(19) United States
(12) Patent Application Publication
(10) Pub. No.: US 2015/0114973 A1
(43) Pub. Date: Apr. 30, 2015

(54) FUSION RIVET COOKING APPARATUS AND METHOD

(71) Applicant: TRAMONTINA USA, INC., Sugar Land, TX (US)

(72) Inventors: Mars MASHBURN, Houston, TX (US); Antonio Galafassi, Houston, TX (US)

(21) Appl. No.: 14/527,022

(22) Filed: Oct. 29, 2014

Related U.S. Application Data
(60) Provisional application No. 61/897,393, filed on Oct. 30, 2013.

(51) Int. Cl. A47J 36/02

(52) U.S. Cl. CPC A47J 36/02
USPC 220/573.1; 29/525.05

(57) ABSTRACT

A cooking apparatus can include a vessel having a cooking surface and an exterior surface, a handle having a grip and a fastener pad, the fastener pad having an opening, and a fastener, wherein the fastener can be coupled to the exterior surface of the vessel, the fastener can be disposed at least partially through the opening, and the handle can be coupled to the vessel. The handle can be coupled to the vessel and any disturbance to the cooking surface can be at least minimized. A method of making a cooking apparatus can include coupling a handle to an exterior surface of a vessel while at least minimizing any effects on the cooking surface.

### CROSS REFERENCE TO RELATED APPLICATIONS

This application claims the benefit of U.S. Provisional Patent Application No. 61/897,393 filed Oct. 30, 2013.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to cookware; and more specifically relate to cooking vessels having one or more handles.

2. Description of the Related Art

Food preparation often requires or makes desirable the use of cookware having one or more handles. Typically, the handles are either formed simultaneously with the cooking vessel (e.g., cast iron cookware) or formed separately and mechanically fastened to the cooking vessel. It is the latter type of cookware with which the present invention is concerned.

In at least some conventional cookware, the handles include holes aligned with holes through the wall of the cooking vessel. A conventional rivet is disposed through each corresponding set of holes in the vessel and handle until the rivet head (e.g., universal, pan, button, etc.) rests against the cooking surface of the vessel. The rivet is pressed in order to force the vessel exterior and handle against one another by expanding the end of the rivet opposite the head. Alternatively, the end of the rivet may be threaded such that the handle can be tightened against the vessel using a nut or by screwing the rivet into the handle and/or vessel. In either case, the rivets pass through the cooking vessel and the rivet head remains disposed against the interior cooking surface of the cookware.

Such conventional arrangements can result in a number of undesirable characteristics. For example, the rivet heads may interrupt an otherwise smooth interior cooking surface. Moreover, the rivet heads may precipitate the buildup of food, oil or other substances, which can result in difficulty cleaning and concerns regarding sanitation. Furthermore, the holes in the cooking vessel and/or the rivets can serve as starting points for oxidation or the breakdown of coatings (e.g., non-stick coatings), or may result in other unwanted characteristics, such as leaks in the vessel.

It is an object of the present invention to at least partially alleviate one or more of the above-mentioned concerns. A further object of the present invention is to provide long-lasting cookware having tough mechanical connections between the vessel and its handle(s). An additional object of the present invention is to provide a commercially and economically viable manner of durably securing handles to cooking vessels. Another object of the present invention is to provide a manner of coupling a handle(s) to a cooking vessel while at least minimizing any effects on the vessel's cooking surface(s), and to provide cookware made in such a manner.

### BRIEF SUMMARY OF THE INVENTION

This disclosure provides a cooking apparatus that can include a vessel having a cooking surface and an exterior surface, a handle having a fastener pad, and one or more fasteners that can couple the handle to the vessel. The handle can be coupled to the vessel and any disturbance to the cooking surface can be at least minimized. This disclosure further provides a method of making a cooking apparatus that can include coupling a handle to an exterior surface of a vessel while at least minimizing any effects on the cooking surface.

A cooking apparatus can include a vessel having a bottom, at least one cooking surface adapted to support items to be cooked, and an exterior surface having at least a first location for a handle. A handle can include a grip portion and a fastener pad portion, and the fastener pad portion can have at least one opening and a mating surface adapted to couple with a portion of the vessel. A fastener can have a body with a first end and a second end. The first end can be coupled to a portion of the vessel and the fastener body can communicate with the opening of the fastener pad. The fastener pad and fastener can be coupled so that the handle can be coupled to the vessel, such as at a first handle location. A cooking surface can include a portion proximate to or near the fastener, such as opposite a handle location. The cooking surface portion can have one or more characteristics, which characteristics can remain at least partially unchanged, substantially unchanged, or otherwise unchanged (or alternatively changed in a known or desired manner) upon coupling a handle to a vessel. A fastener can include more than one fastener, and can include a rivet, rivet stud, or other fastener. A cooking apparatus can include a plurality of handles, and can include a lid or top having one or more handles.

A method of making a cooking apparatus can include providing a vessel having a bottom, at least one cooking surface that can support items to be cooked and/or during cooking, and an exterior surface, and providing a first handle having at least one fastener or coupler portion that can couple with the vessel at one or more handle locations. A method can include providing at least a first fastener that can have a body, a first end and a second end, and coupling the fastener to a surface of the vessel. A method can include aligning a handle and a fastener, disposing a fastener relative to an opening of a fastener pad, and aligning a vessel and a handle. A method can include coupling one or more fasteners to a vessel, such as by welding or another manner, and can include coupling a handle to one or more fasteners. A method can include coupling a fastener to an exterior surface of a vessel at a first handle location while at least minimizing any effects on a cooking surface or portion thereof. A fastener need not pass through a cooking surface of a vessel. A method can include coupling a plurality of handles to a vessel, and can include providing, forming, otherwise making available and/or combining any one or more of the components described herein.

### BRIEF DESCRIPTION OF THE SEVERAL VIEWS OF THE DRAWINGS

FIG. 1A illustrates a side view of the components of one of many embodiments of a cooking apparatus according to the disclosure.

FIGS. 1B, 1C and 1D are illustrations of the apparatus of FIG. 1A in three respective configurations during assembly.

FIG. 2A illustrates a rear view of one of many embodiments of a cooking vessel according to the disclosure.

FIGS. 2B, 2C and 2D illustrate rear views of the vessel of FIG. 2A and other components of one of many embodiments of a cooking apparatus according to the disclosure.

FIG. 3A is a cross-sectional schematic view of the cooking apparatus of FIG. 1D according to the disclosure.

FIG. 3B is a detail section view of a portion of FIG. 3A.

FIG. 4A illustrates one side of one of many embodiments of a cooking apparatus handle according to the disclosure.

FIG. 4B illustrates another side of the cooking apparatus handle of FIG. 4A.

FIG. 5A is an isometric schematic view of one of many embodiments of a fastener according to the disclosure.

FIG. 5B is another isometric schematic view of the fastener of FIG. 5A.

FIG. 6A is an isometric schematic view of another of many embodiments of a cooking apparatus according to the disclosure.

FIG. 6B is another isometric schematic view of the apparatus of FIG. 6A.

FIG. 7A is an isometric schematic view of yet another of many embodiments of a cooking apparatus according to the disclosure.

### DETAILED DESCRIPTION OF THE INVENTION

The Figures described above and the written description of specific structures and functions below are not presented to limit the scope of what Applicant has invented or the scope of the appended claims. Rather, the Figures and written description are provided to teach any person ordinarily skilled in the art to make and use the invention for which patent protection is sought. Those skilled in the art will appreciate that not all features of a commercial embodiment of the invention are described or shown for the sake of clarity and understanding. Persons of skill in this art will also appreciate that the development of an actual commercial embodiment incorporating aspects of the present invention will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location, and from time to time. While a developer's efforts might be complex and time-consuming in an absolute sense, such efforts would be, nevertheless, a routine undertaking for those of ordinary skill in this art having benefit of this disclosure. It must be understood that the invention disclosed and taught herein is susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. When referring generally to such elements, the number without the letter is used. Further, such designations do not limit the number of elements that can be used for that function. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. The terms “including” and “such as” are illustrative and not limitative. The term “can” as used herein means “can, but need not” unless otherwise indicated. Each structure, component and other item included herein will have certain inherent physical characteristics when and if present in one or more physical embodiments of the present inventions, such as dimension(s) (e.g., height, width, length, diameter), mass, weight, imaginary axes, cross-sections and the like. It will be understood by a person of ordinary skill in the art that such characteristics are present, and that such items exist in one or more environments, regardless of whether expressly described or mentioned herein.

This disclosure provides a cooking apparatus that can include a vessel having a cooking surface and an exterior surface, a handle having a fastener pad, and one or more fasteners that can couple the handle to the vessel. A handle can be coupled to the vessel and any disturbance to the cooking surface can be at least minimized. This disclosure further provides a method of making a cooking apparatus that can include coupling a handle to a surface of a vessel while at least minimizing any effects on the cooking surface.

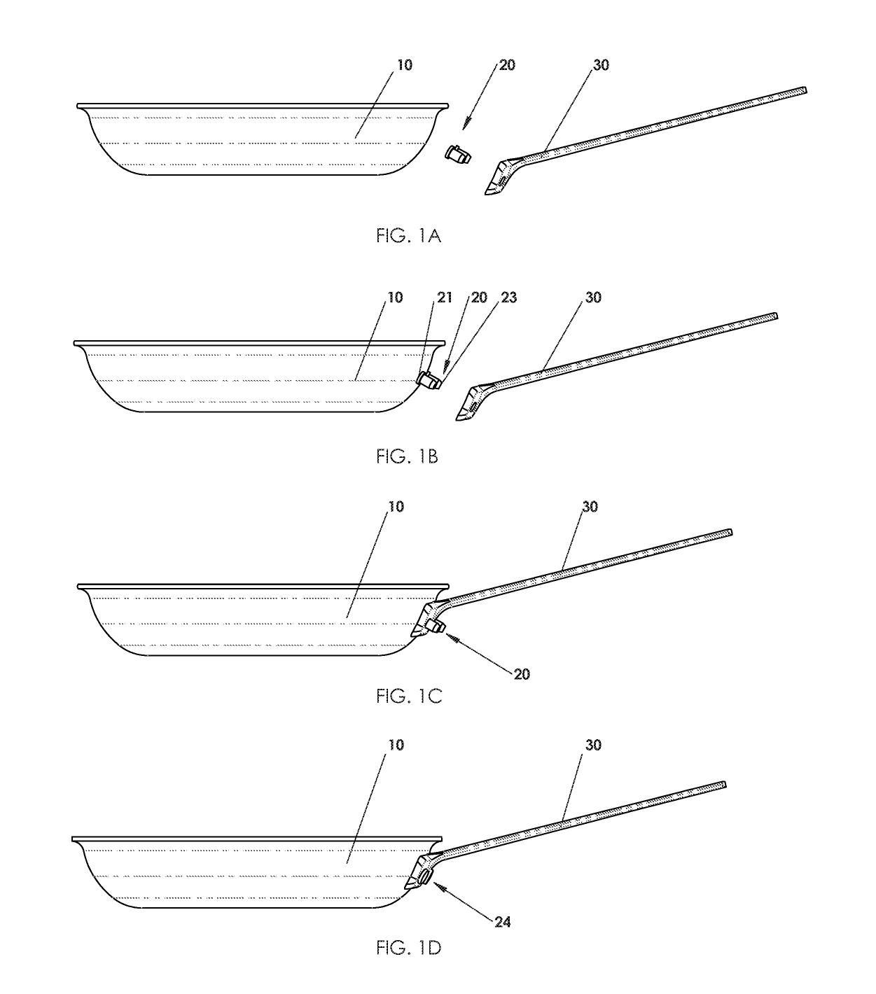

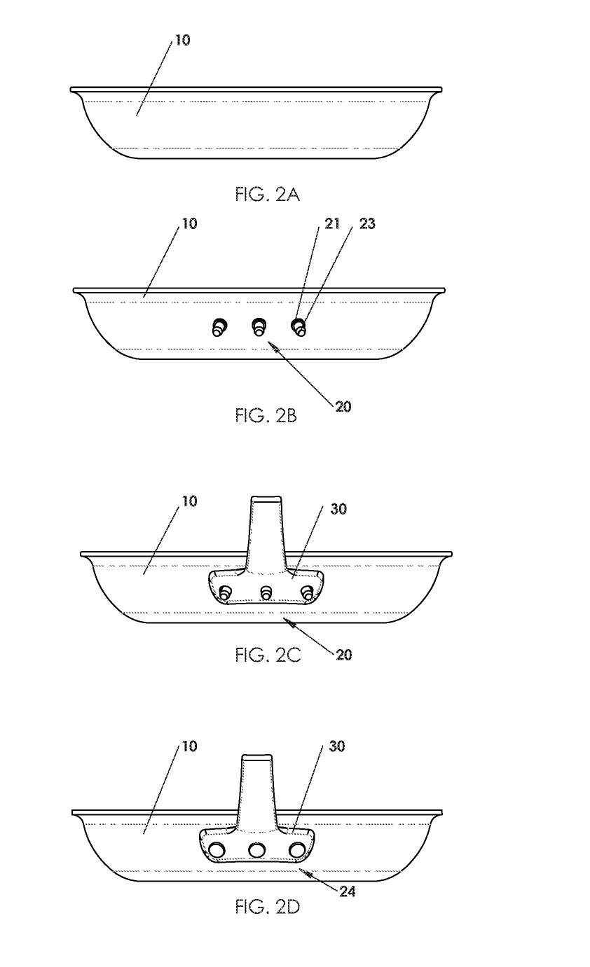

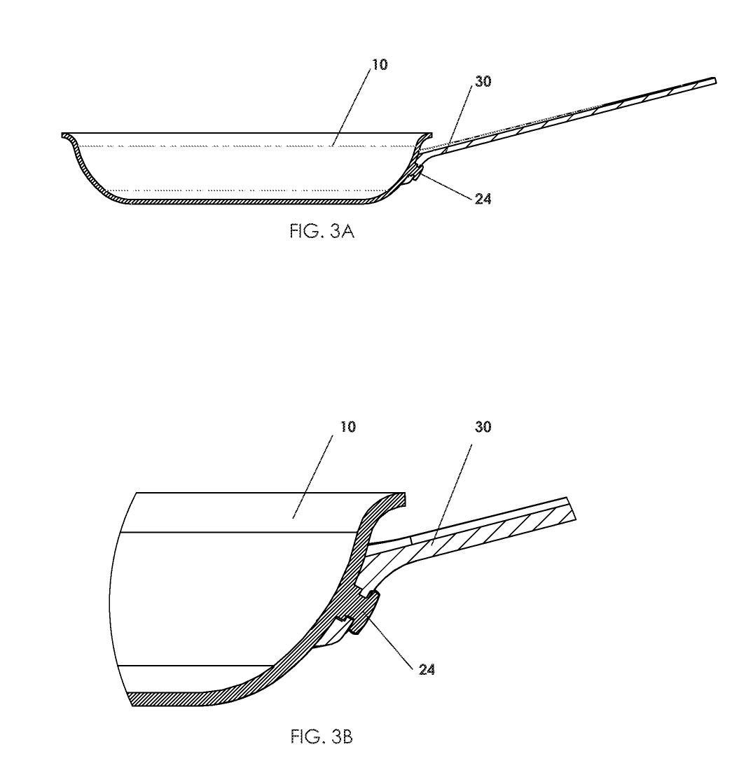

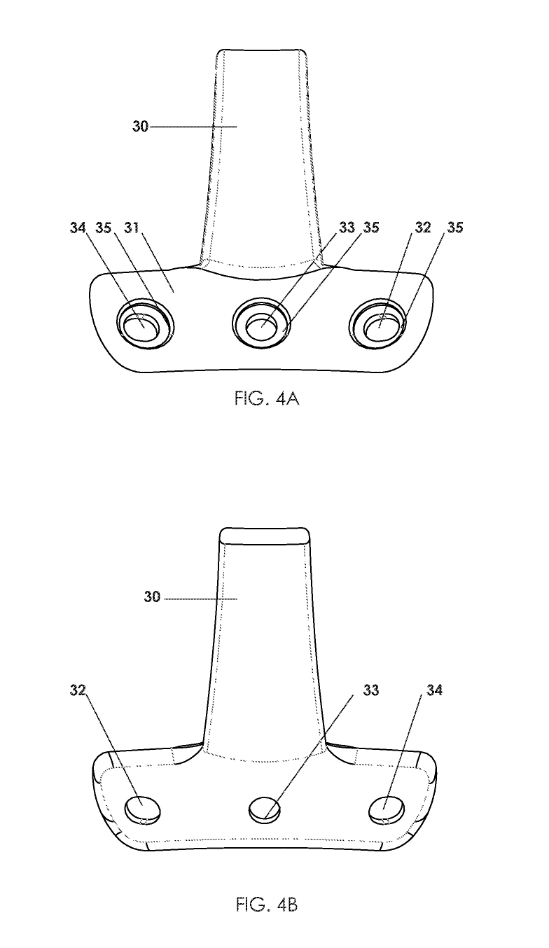

FIG. 1A illustrates a side view of the components of one of many embodiments of a cooking apparatus according to the disclosure. FIGS. 1B, 1C and 1D are illustrations of the apparatus of FIG. 1A in three respective configurations during assembly. FIG. 2A illustrates a rear view of one of many embodiments of a cooking vessel according to the disclosure. FIGS. 2B, 2C and 2D illustrate rear views of the vessel of FIG. 2A and other components of one of many embodiments of a cooking apparatus according to the disclosure. FIG. 3A is a cross-sectional schematic view of the cooking apparatus of FIG. 1D according to the disclosure. FIG. 3B is a detail section view of a portion of FIG. 3A. FIG. 4A illustrates one side of one of many embodiments of a cooking apparatus handle according to the disclosure. FIG. 4B illustrates another side of the cooking apparatus handle of FIG. 4A. FIGS. 1-4B will be described in conjunction with one another. Cooking apparatus 100 can include a cooking vessel 10, such as a pot, pan, or other cookware body for supporting one or more items to be cooked or during cooking (e.g., food). Vessel 10 can have a bottom 12, which can, but need not, be or include the bottommost surface of the vessel, in whole or in part, and can have a cooking surface 14 for transferring heat to one or more items during cooking (if present). For purposes of convenience, cooking surface 14 also may be referred to as the “interior” or “interior surface” of the vessel, while the opposite outer surface (of which the surface of bottom 12 is a part) may be referred to as the “exterior” or “exterior surface.” For purposes of convenience, the outer surface of vessel 10 generally will be referred to herein as exterior surface 13. Of course, as will be readily understood by a person of ordinary skill having the benefits of the present disclosure, the interior and exterior surfaces are not limited to a single surface, but rather can each comprise a plurality of surfaces in at least some embodiments. Vessel 10 can have a thickness t, which can be uniform throughout the structure of the vessel, but need not be, and can alternatively vary as required by a particular application. The thickness t of vessel 10 can depend on any number of application-specific factors, including materials, weight, heat load, purpose, etc., which can vary from application to application. Vessel 10 can have a rim 16, such as a border or surrounding structure, disposed at least partially about its periphery. As shown in the drawings for illustrative purposes, vessel 10 is circular in cross-section, but it need not be, and can alternatively be square, rectangular or another shape required by a particular application (e.g., having more or less than four sides). One or more surfaces of vessel 10, such as cooking surface 14 or another surface (e.g., exterior surface 13), can, but need not, include one or more coatings, such as a non-stick, wear-resistant, textured, painted, porcelain, enamel, heat-resistant, or other coating, in whole or in part.

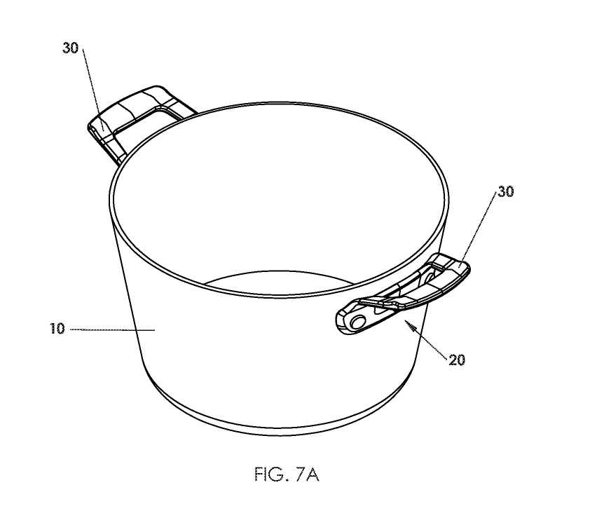

Apparatus 100 can also include one or more handles 30, such as an extension or holder, for holding, supporting and/or manipulating the apparatus. Each handle 30 can include one or more portions, such as a grip 30a for grasping the handle and a fastener pad 30b for mating the handle with a particular vessel 10. Handle 30 can be any shape required by a particular application, and the grip 30a and pad 30b can be coupled to one another in any manner, including being formed integrally as one, in whole or in part. In at least one application, such as a frying pan, sauté pan or similar application, grip 30a can, but need not, be relatively long as compared to the size of the vessel 10 (see, e.g., FIG. 1D), whereas in other applications, such as for a pot or similar application, grip 30a can, but need not, be relatively short (see, e.g., FIG. 7A). Of course, as a person of ordinary skill will understand, any type of pot, pan or other vessel in accordance with the present invention can have any number of handles 30 coupled thereto (e.g., one, two, three, four, or more), each of which can be of any size and type required by or otherwise desired for a particular application. For example, a pan-style application can include one or more relatively short handles, and a pot-style application can include one or more relatively long handles. The apparatuses and arrangements shown in the Figures are of course only examples presented for illustrative purposes. As shown in FIGS. 1-3B, and as further described below, pad 30b can be a single structure, but this need not be the case. Alternatively, pad 30b can include a plurality of structures, such as prongs, sections, or other portions, which can, but need not, be formed or otherwise coupled with one another apart from being coupled with the grip 30a portion of handle 30.

With continuing reference to FIGS. 1-3B, and specific reference to FIGS. 4A-4B, fastener pad 30b can be any size and shape required by a particular application, including of a size and shape applicable to mate the pad with at least a portion of vessel 10, such as exterior surface 13. For example, pad 30b can include one or more mating surfaces 31 for coupling (whether directly or indirectly) with a handle location 34 on exterior surface 13, which can be any location or plurality of locations on surface 13, in whole or in part. In at least one embodiment, such as that shown in FIGS. 1-3B for illustrative purposes, mating surface 31 can be contoured or otherwise shaped to mesh, conform, or otherwise communicate with at least a portion of a handle location 34, which can include being configured to be disposed at least partially flat or flush with a portion of vessel 10. Alternatively, mating surface 31 and handle location 34 need not be flush with one another. Mating surface 31 and handle location 34 can, but need not, be in contact with one another, in whole or in part, when handle 30 and vessel 10 are coupled together. For example, one or more media (not shown) can be disposed between mating surface 31 and handle location 34 (or portions thereof), such as a gasket, barrier (e.g., heat shield), adhesive, seal or other material or structure. Fastener pad 30b can include one or more openings 32, such as exemplary openings 32a, 32b, 32c, for coupling with one or more fasteners 20 further described below. Although three openings 32a, 32b, 32c (collectively referred to as opening 32 for purposes of convenience and not limitation) are shown for illustrative purposes, apparatus 100 can include any number of openings required by a particular application, for example, one, two, three, four, or more openings. Opening 32 can include any type of opening required by a particular application, such as partial or thru holes, open-ended slots, closed slots, or other voids of applicable sizes and shapes. As shown in FIGS. 1-4B, for example, pad 30b includes a thru hole 32a and two slots 32b, 32c, although this need not be the case. In at least one embodiment, opening 32 can include at least one oversized (e.g., larger than an associated fastener in at least one dimension, as further described below) hole, such as one or more slots 32b, 32c, which can assist in alignment between handle 30 and vessel 10 during manufacturing or assembly, as described elsewhere herein. Opening 32 can, but need not, include one or more recesses 35, such as a receding part, cavity, or space, for accepting and/or coupling with at least a portion of one or more other components of cooking apparatus 100. For example, recess(es) 35 can accommodate or facilitate the use of one or more types of couplers or coupling methods, as discussed in further detail below. A recess 35 can be of any size and shape required by a particular application, and can be disposed anywhere on handle 30, including on the mating surface 31 side of pad 30b and/or on the opposite exterior side 36 of the fastener pad. Recess 35 can be formed in any manner required by a particular application, such as machining, drilling, counter-boring, or other manners. As shown for purposes of illustration in FIG. 4A, for example, pad 30b can include one or more recesses 35 disposed about (e.g., by wholly or partially surrounding or circumscribing) at least one of openings 32 on the mating surface 31 side of fastener pad 30b. In such an embodiment, which is but one example of many, opening(s) 32 can be configured to receive or cover at least a portion of a fastener or coupler, as further explained below.

Apparatus 100 can include one or more fasteners 20, such as a pin, rod, stud or other coupler, for coupling one or more handles 30 to vessel 10. Each fastener 20 can be any type of coupler required by a particular application in accordance with the disclosure, and can be coupled to apparatus 100, for example, in any location on or about exterior surface 13 of vessel 10. In at least one embodiment, such as the one shown in FIGS. 1-3B for exemplary purposes, one or more fasteners 20 can be coupled to a side 18, such as a wall or panel, of vessel 10, which can include any location on or about the side. For example, a fastener 20 can be coupled to the bottom of the side adjacent to bottom 12, to the top of the side near or in contact with rim 16 (if present), or anywhere in between. As will be understood by a person of ordinary skill having the benefit of Applicant's disclosure, the term “side” as used here includes any type of boundary portion, regardless of the cross-sectional shape of the vessel for a particular embodiment of apparatus 100 (e.g., cylindrical, oblong, polygonal, etc.); furthermore, the location, size, number and orientation of fastener(s) 20 will be an implementation specific consideration in accordance with a particular embodiment and can depend on any number of factors, such as durability, weight, component orientation, and other factors, as further described elsewhere in this application. In at least some embodiments of the present invention, for example, apparatus 100 can include a number of fasteners 20 corresponding to a number of openings 32 in fastener pad 30b, although this need not be the case and, in other embodiments, the number of fasteners and openings can differ.

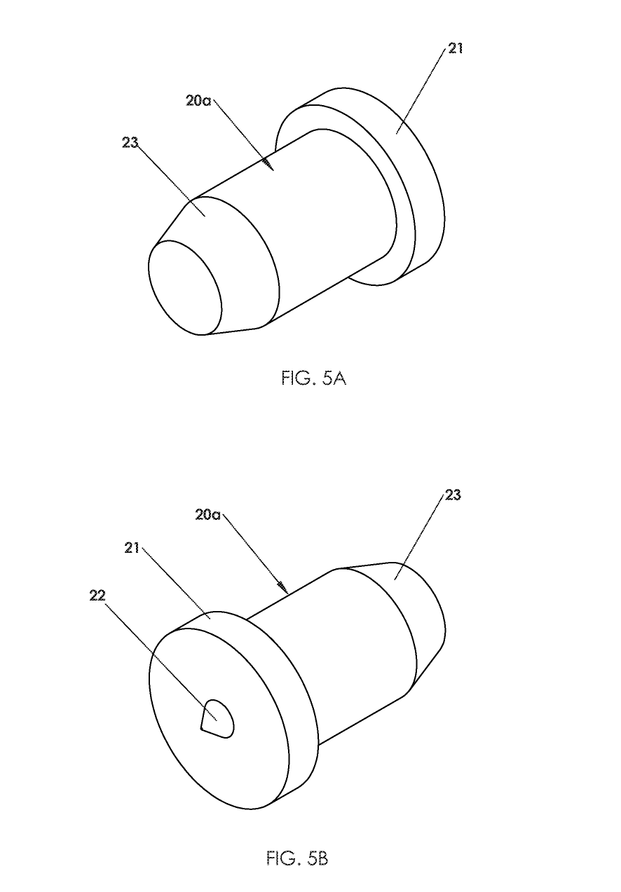

FIG. 5A is an isometric schematic view of one of many embodiments of a fastener according to the disclosure. FIG. 5B is another isometric schematic view of the fastener of FIG. 5A. FIGS. 5A-5B will be described in conjunction with one another. In at least one preferred embodiment of the present invention, one or more fasteners can be a rivet 40, and can preferably be a rivet stud (a.k.a a “rivet/stud” and other similar terms). In such embodiments, rivet 40 can include, for example, a rivet body 42 having a base end 42a and a head end 42b. Rivet 40 can include a support 21, such as a projecting rim, collar, ring, or extension, for facilitating the coupling of rivet 40 to another component of the apparatus. Support 21 can be coupled to rivet body 42 in any manner and location required by a particular application, including, for example, to base end 42a, and can, but need not, at least partially disperse or distribute one or more loads applied to apparatus 100, such as during use, storage, or otherwise. In at least one embodiment, such as that shown in FIGS. 5A-5B for exemplary purposes, support 21 can be a flange, such as a welding flange or disk, that is coupled about or to base end 42a. Alternatively, support 21 need not be annular, and can instead include one or more tabs or protrusions extending radially outwardly from body 42. As will be understood by a person of ordinary skill having the benefits of Applicant's disclosure, support 21 can be, or can include one or more portions having, any size and shape required by or desired for a particular application (e.g., circular, square, rectangular, oblong, etc.), and can preferably be arranged to provide additional surface area to at least assist with coupling of the rivet 40 to a vessel 10 or other component of a cooking apparatus 100. Additionally, rivet 40 optionally can include a projection 22 formed with or otherwise coupled to base end 42a, which can include being coupled to either or both of body 42 and support 21. Projection 22, which can be, for example, a point, cone, protrusion or other extension, such as a welding projection, can at least partially extend from base end 42a in the direction of the rivet's central longitudinal axis A. Projection 22 can be used, for example, to support alignment and coupling of one or more components during formation or assembly, as described in further detail below. On its longitudinally opposite head end, rivet 40 can, but need not, include a modified edge 23, such as an at least partially chamfered, ground, curved, or reduced edge, for supporting alignment or coupling of one or more components during formation or assembly, as will also be described in further detail below. Edge 23 can be formed along with body 42, but need not be, and can alternatively be formed at a later time, such as by machining, grinding or the like.

Vessel 10, handle 30 and fasteners 20 can be made or formed from any material or combination of materials required by a particular application, such as steel, aluminum or other materials suitable for an application at hand, whether separately or in combination, in whole or in part. One or more of vessel 10, handle 30 and fasteners 20 can, but need not, be formed from the same type of material or materials. In at least one embodiment, each fastener 20 can be formed at least partially from a material that facilitates coupling of the various components to one another, such as, for example, by supporting welding or fastener expansion during construction of one or more embodiments, as discussed elsewhere herein. In at least one embodiment, which is but one of many, handle 30 can be formed from, for example, 304 stainless steel or another material, and vessel 10 can be formed from 3004 series aluminum or another material, separately or in combination. Of course, these materials are exemplary and not limitative.

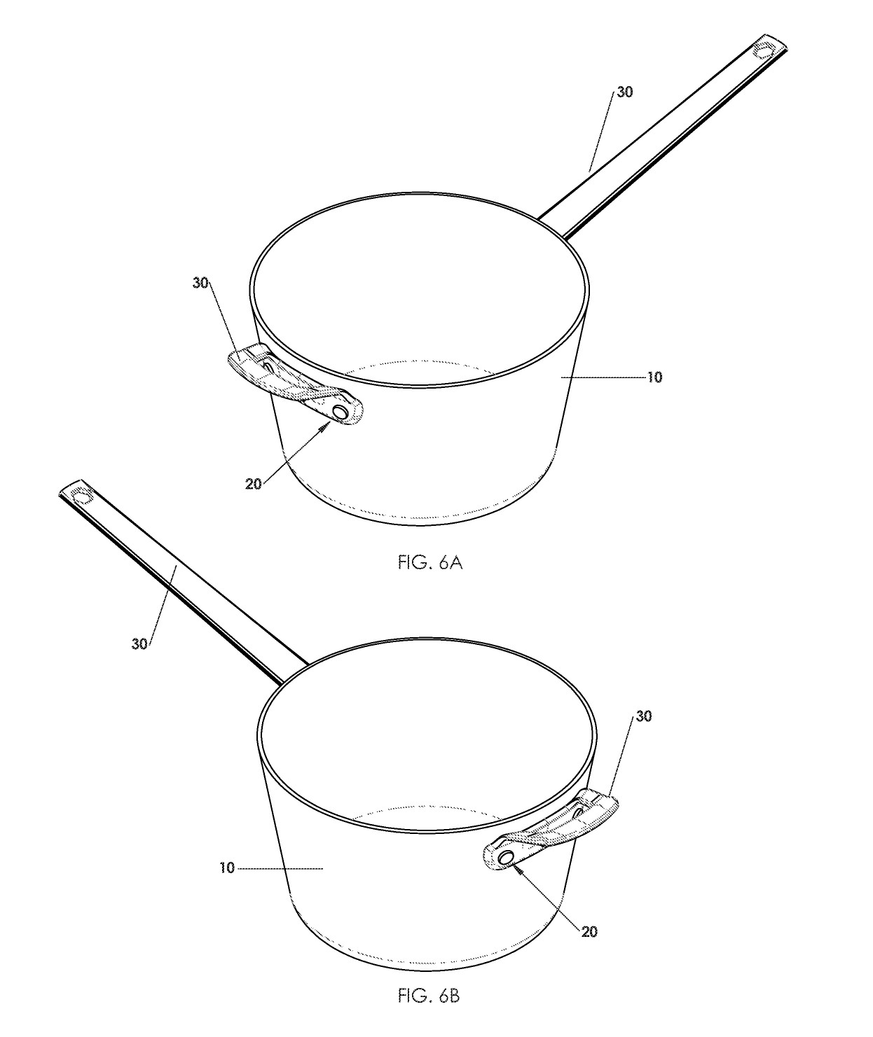

FIG. 6A is an isometric schematic view of another of many embodiments of a cooking apparatus according to the disclosure. FIG. 6B is another isometric schematic view of the apparatus of FIG. 6A. FIG. 7A is an isometric schematic view of yet another of many embodiments of a cooking apparatus according to the disclosure. FIGS. 6A-7A will be described in conjunction with one another. With reference to FIGS. 6A-6B, cooking apparatus 200 illustrates another embodiment of the present invention, namely, a saucepan or similar application. Apparatus 200 can include a vessel 210 having one or more handles, such as a long handle 230a and a short (or “side”) handle 230b (collectively, handles 230), coupled thereto. Each handle 230 can be coupled to vessel 210 by way of one or more fasteners 220 in accordance with the methods described herein. One or more handles 230 can, but need not, include one or more openings 232 disposed there through, such as for facilitating storage of the apparatus, for example, by hanging from a hook, pot rack, or other storage device or system. With reference to FIG. 7A, cooking apparatus 300 illustrates yet another embodiment of the present invention, namely, a saucepot or similar application. Apparatus 300 can include a vessel 310 having one or more handles, such as a first handle 330a and a second handle 330b (collectively, handles 330), coupled thereto. Each handle 330 can be coupled to vessel 310 by way of one or more fasteners 320 in accordance with the methods described herein. As will be understood by a person of ordinary skill having the benefits of the present disclosure, the terms “long” and “short” refer to the relative lengths of the exemplary handles shown in FIGS. 6A-7A (and others, e.g., FIGS. 1-4B) for illustrative purposes, are used for convenience of explanation, and are not intended to be limiting or to imply any particular measurements or sizes. Alternatively, cooking apparatuses 200, 300 can include any number of handles required by a particular application, each of which can be of any shape, size, length and type, including short, long, or otherwise, whether the same or different as one or more other handles included on the apparatus (if present). Typically, the saucepan and saucepot embodiments of FIGS. 6A-7A may be relatively deeper, and may have relatively taller sides, than a frying or sauté pan embodiment (e.g., the embodiment of FIG. 1D), although that need not be the case. Otherwise, the various methods, materials, components and characteristics described herein with respect to the embodiments of FIGS. 1-5B are generally applicable to the other exemplary embodiments of FIGS. 6A-7A and therefore need not be repeated here.

Having described above the components of one or more exemplary embodiments of Applicant's inventive cooking apparatuses 100, 200, 300, one or more methods of making these devices will now be described below. The steps will be described with reference to apparatus 100 for purposes of convenience and illustration, and not by way of limitation, as apparatuses 200, 300, among others, can be produced in at least similar manners. With continuing reference to the FIGS. described above, and with specific reference to FIGS. 1A-4B, at least one of many methods of making the embodiment of cooking apparatus 100 shown in FIGS. 1D, 2D and 3A, which is but one of many, can be described. A vessel 10, one or more fasteners 20, and one or more handles 30 can be provided, each of which can be of any size, shape and material required or otherwise called for by a particular application. Each of the aforesaid components can, but need not, be custom made; alternatively, one or more can be readily available, off-the-shelf elements. Generally speaking, the one or more fasteners 20 can be coupled to vessel 10, passed through corresponding openings 32 in handle 30, and coupled to handle 30 to thereby couple handle 30 to vessel 10. In at least one preferred embodiment, these steps can be accomplished while at least minimizing or even avoiding any disturbance of the state or integrity of cooking surface 14 of vessel 10, for example, as such surface exists prior to the coupling of vessel 10 and handle 30. More specifically, a handle location 34 on exterior surface 13 of vessel 10 can be selected, which can include any location or area, for example, on or including at least a portion of surface 13. At least one fastener 20, such as a first fastener 20a (which can include a sole fastener), can be disposed on or near exterior surface 13, such as at a location within the surface area chosen for a handle location 34 with respect to a particular embodiment (which can be one of many) being produced. Fastener 20a can be coupled to vessel 10 within handle location 34 in any manner required by a particular application, and preferably can be coupled in a manner that at least limits any effects upon cooking surface 14, such as upon the portion of cooking surface 14 opposite handle location 34 on the vessel. Fastener 20a can be coupled to vessel 10, for example, by welding, fusing, soldering, bonding, brazing, cementing, or in one or more other ways, such as by heat staking, in whole or in part, separately or in combination. In at least one preferred embodiment, which is but one of many, fastener 20a can be secured to vessel 10 by way of resistance welding. As one of ordinary skill will understand, in embodiments wherein an optional coating or other substance may be present on the exterior surface of the vessel or one or more other components, such materials or portions thereof (if present) can be removed (e.g., by machining, washing, grinding, or other methods) as needed (and if needed) to allow or aid coupling of the various components.

One or more additional fasteners 20, such as optional second fastener 20b and third fastener 20c (as well as additional fasteners, if present), can, but need not, be coupled to vessel 10, for example, in the same or a similar manner to that described above for first fastener 20a (or in a different manner, as the case may be). One or more fasteners 20 can be coupled to vessel 10 directly (e.g., as described above) or indirectly (e.g., by way of being coupled to an intervening structure(s) (not shown) coupled to vessel 10). The one or more fasteners 20 can be positioned or otherwise arranged on or about exterior surface 13 in any manner required by a particular application, including, for example, in a pattern or arrangement corresponding to one or more openings in a handle to be coupled to the vessel, such as to openings 32 in fastener pad 30b of handle 30. In an embodiment wherein the fastener is a rivet 40 or other fastener having a projection 22 (see, e.g., FIG. 5B), which is but one of many, projection 22 can, but need not, be utilized to assist with placement of the fastener in a desired location, such as by at least helping to avoid slipping or unintentional movement of fastener 20 prior to or during coupling of the fastener to vessel 10. Projection 22 can, but need not, at least partially change form during coupling, such as by flattening, melting, or bonding with one or more adjacent components. As shown, for example, in FIG. 1B, one or more fasteners 20 can be arranged and oriented so that each one passes at least partially through a corresponding opening in a corresponding handle. Although, as shown in FIGS. 1C and 2C for exemplary purposes, each fastener 20 can pass completely through a corresponding opening 32 in handle 30, this need not be the case. Alternatively, for example, one or more fasteners 20 (e.g., fasteners 20b, 20c) can have a length less than a thickness of fastener pad 30b and, for example, can pass only partially into a corresponding opening in pad 30b, such as a thru hole, non-thru hole, or other opening. Handle 30 can be aligned with vessel 10, such as with one or more fasteners 20, and can be disposed in contact with or near exterior surface 13. In at least one embodiment, which is but one of many, mating surface 31 of pad 30b can be placed or held (directly or indirectly) against handle location 34, such as by hand, fixture, jig or in any other manner called for by a particular application, such as by way of one or more components of a press or other coupling device. Such devices or portions thereof (if present) can be arranged, for example, to at least minimize any unwanted changes, damage or ghosting to vessel 10 during assembly or production. As explained elsewhere herein, apparatus 100 can, but need not include, one or more intervening structures or materials disposed at least partially between vessel 10 and handle 30, such as a gasket, thermal shield, or adhesive, or other items, such as a decorative plate or border, separately or in combination.

In an embodiment wherein one or more fasteners 20 include a support 21 or, for example, any other items or materials (e.g., weld material, joint material, washers, etc.) around or near an end coupled to vessel 10, handle 30 can include or can be modified to include a recess 35 for at least partially accommodating or receiving such structure(s) or material(s). Of course, recess 35 can be present regardless of whether such accommodation is called for by a particular application. One or more fasteners can be coupled to handle 30, such as to fastener pad 30b or a portion thereof, to couple handle 30 to vessel 10. In an embodiment wherein one or more fasteners is a rivet 40, which is but one of many, the rivet(s) 40 can be pressed (e.g., by a hydraulic or other press) or otherwise manipulated, which can, for example, expand head end 42b, such as to produce a formed rivet head 24 (see FIGS. 3A-3B). Rivet head 24 can be, for example, disposed on exterior side 36 of fastener pad 30b and can at least partially couple handle 30 to vessel 10 by way of forcing exterior surface 13 and mating surface 31 toward or against one another (directly or indirectly), separately or in combination with other manners of coupling. In at least one embodiment, which is but one of many, a plurality of fasteners (if present) can be fastened simultaneously, although this need not be the case and each fastener can be fastened or otherwise manipulated separately. The methods and steps described above can be repeated, in whole or in part and in any order, to couple one or more additional handles 30 to a vessel 10, if present and/or called for by a particular application.

Other and further embodiments utilizing one or more aspects of the inventions described above can be devised without departing from the spirit of Applicant's invention. For example, the methods disclosed herein can be used to form other types or shapes of cooking equipment, such as baking pans, griddles, serving dishes and the like. As another example, the methods disclosed herein can be used to form one or more parts of such cooking apparatuses, such as a top or lid, whether removable or otherwise. Further, the various methods and embodiments of the cooking apparatuses can be included in combination with each other to produce variations of the disclosed methods and embodiments. Discussion of singular elements can include plural elements and vice-versa. References to at least one item followed by a reference to the item may include one or more items. Also, various aspects of the embodiments could be used in conjunction with each other to accomplish the understood goals of the disclosure. Unless the context requires otherwise, the word “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by Applicant, but rather, in conformity with the patent laws, Applicant intends to fully protect all such modifications and improvements that come within the scope or range of equivalents of the following claims.

What is claimed is:

1. A cooking apparatus, comprising:
a vessel having a bottom, at least one cooking surface configured to support items to be cooked and an exterior surface, the exterior surface including at least a first handle location;
a first handle having a grip and a fastener pad, the fastener pad having at least one opening there through and a mating surface configured to couple with the exterior surface of the vessel at the first handle location; and
a first fastener having a body with a first end and a second end;
wherein the first end of the first fastener is coupled to the exterior surface of the vessel at the first handle location;
wherein the body of the first fastener is disposed at least partially through the at least one opening of the fastener pad; and
wherein the fastener pad and first fastener are coupled so that the first handle is coupled to the vessel at the first handle location.

2. The cooking apparatus of claim 1, further comprising:
wherein the cooking surface includes a cooking surface portion disposed opposite the first handle location; and
wherein the cooking surface portion is smooth.

3. The cooking apparatus of claim 1, further comprising:
wherein the cooking surface includes a cooking surface portion disposed opposite the first handle location; and
wherein the cooking surface portion is uninterrupted by the first fastener.

4. The cooking apparatus of claim 1, further comprising a support coupled to the first end of the first fastener.

5. The cooking apparatus of claim 1, further comprising:
wherein the first fastener is a rivet having a rivet head; and
wherein the fastener pad of the first handle is fixed to the vessel between the exterior surface of the vessel and the rivet head.

6. The cooking apparatus of claim 1, further comprising a recess disposed in the mating surface of the fastener pad, the recess being at least a portion of the at least one opening through the fastener pad.

7. The cooking apparatus of claim 1, wherein the fastener pad of the first handle further comprises a plurality of fastener pads.

8. The cooking apparatus of claim 1, further comprising a second handle having a second fastener pad, the second fastener pad being coupled to the vessel at a second handle location on the exterior surface with at least a second fastener, the second fastener being a rivet having a first end coupled to the exterior surface of the vessel and configured to force the second fastener pad and the exterior surface of the vessel toward one another.

9. A method of making a cooking apparatus, comprising:
providing a vessel having a bottom, at least one cooking surface configured to support items to be cooked and an exterior surface, the exterior surface including a first handle location;
providing a first handle having a grip and a fastener pad, the fastener pad having at least one opening there through and a mating surface configured to couple with the exterior surface of the vessel at the first handle location;
providing a first fastener having a body with a first end and a second end;
coupling the first end of the first fastener to the exterior surface of the vessel at the first handle location;
aligning the at least one opening with the first fastener;
disposing the first fastener at least partially through the at least one opening of the fastener pad;
aligning the mating surface with the exterior surface of the vessel at the first handle location; and
coupling the fastener pad and the first fastener, thereby coupling the first handle to the exterior surface of the vessel at the first handle location with the mating surface and the exterior surface of the vessel facing one another.

10. The method of claim 9, further comprising welding the first end of the first fastener to the exterior surface of the vessel.

11. The method of claim 9, wherein the fastener pad has a plurality of openings there though, the method further comprising:
providing a fastener for each of the plurality of openings;
coupling a first end of each fastener to the exterior surface of the vessel;
disposing each fastener at least partially through a corresponding one of the plurality of openings; and
manipulating each fastener so that the first handle is coupled to the vessel.

12. The method of claim 11, wherein each fastener is a rivet having a second end that extends from its corresponding opening in the fastener pad, the method further comprising expanding the second end of each fastener to form a rivet head on a side of the fastener pad opposite the mating surface.

13. The method of claim 9, wherein the cooking surface includes a cooking surface portion disposed opposite the first handle location, the method further comprising coupling the first end of the first fastener to the exterior surface of the vessel at the first handle location while at least minimizing any effects on the cooking surface portion.

14. The method of claim 9, wherein the cooking surface includes a cooking surface portion disposed opposite the first handle location, the method further comprising coupling the first handle to the exterior surface of the vessel at the first handle location without passing the first fastener through the cooking surface portion.

15. The method of claim 9, wherein the fastener pad includes a recess in the mating surface, the method further comprising disposing at least a portion of the first fastener in the recess.

16. A cooking apparatus, comprising:
a vessel having a bottom, at least one cooking surface configured to support items to be cooked and an exterior surface, the exterior surface including at least a first handle location;
a first handle having a grip and a fastener pad, the fastener pad having a plurality of openings there through and a mating surface configured to couple with the exterior surface of the vessel at the first handle location; and
a plurality of rivet studs each having a first end and a second end;
wherein the first end of each rivet stud is coupled to the exterior surface of the vessel at the first handle location;
wherein the plurality of rivet studs are arranged at the first handle location so that each rivet stud corresponds to a corresponding one of the plurality of openings in the fastener pad;
wherein the second end of each of the plurality of rivet studs is disposed through its corresponding one of the plurality of openings in the fastener pad;
wherein the second end of each of the plurality of rivet studs forms a rivet head; and
wherein the plurality of rivet studs force the mating surface of the fastener pad and the exterior surface of the vessel toward one another so that the first handle is coupled to the vessel.
